(19) United States
(12) Patent Application Publication
(10) Pub. No.: US 2011/0113987 A1
(43) Pub. Date: May 19, 2011

(54) PROCESS FOR MANUFACTURING CEMENT CLINKER IN A PLANT, AND CEMENT CLINKER MANUFACTURING PLANT AS SUCH

(75) Inventors: Serge Jorget, Marcq en Baroeul (FR); Sébastien Devroe, Bouvines (FR)

(73) Assignee: Fives FCB, Villenueve D'Ascq (FR)

(21) Appl. No.: 13/003,257

(22) PCT Filed: Jul. 17, 2009
(86) PCT No.: PCT/FR09/00884

§ 371 Date: Jan. 7, 2011

(30) Foreign Application Priority Data
Aug. 1, 2008 (FR) 08/04407

(51) Int. Cl. C04B 2/10; B01J 19/00

(52) U.S. Cl. 106/771; 422/198

(57) ABSTRACT

The invention relates to a process for manufacturing cement clinker in a plant having a cyclone preheater, a precalcination reactor, a rotary furnace and a clinker cooler. According to the invention, the flue gases produced by the rotary furnace are separated from the gases from the preheater so as not to mix them, the precalcination reactor is fed with an oxygen-rich gas and a portion of the gases leaving the cyclone preheater is recycled into said precalcination reactor, or even into the preheater so as to obtain a flux suitable for suspending matter in the preheater. The non-recycled other portion of the gases, rich in carbon dioxide, is adapted for the purpose of limiting the amount of CO2 discharged, by means such as sequestration means.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention concerns a method for manufacturing a cement clinker in a plant as well as a cement clinker manufacturing plant as such.

2. Description of Related Art Including Information Disclosed Under 37 CFR 1.97 and 37 CFR 1.98

The manufacture of cement uses for its greatest part a baked matter, clinker, which is generated from minerals whose essential constituent is calcium carbonate. Clinker is prepared using a baking operation which produces large amounts of carbon dioxide, by the decomposition of calcium carbonate as well as the combustion of the fuel necessary to the operation.

For example, the production of a ton of so-called Portland cement thus emits approximately 530 kg CO2 from the treated matter and 250 to 300 kg CO2 from the fuel. This carbon dioxide is emitted in fumes, at a concentration lower than 30%, wherein the principal component of the fumes is nitrogen. Under these conditions, it is difficult to isolate, in particular in sequestrate for the purpose of limiting the discharges of CO2 into the atmosphere.

Manufacturing a cement clinker most often uses a so-called dry baking process, where the previously crushed raw matter is calcinated in a rotary furnace. So as to reduce the energy requirements of the operation, exchangers have been added upstream and downstream of the rotary furnace and directly recover the heat contained in the matter and the fumes coming out of the furnace. Upstream, a cyclone preheater is provided where the raw matter is preheated in suspension, and partially decarbonated. Downstream, a clinker cooler is provided where the baked matter is cooled by cold-air blowing. Most plants operating in so-called dry mode comprise a combustion reactor at the bottom of the preheater, referred to as precalcinator, wherein a significant portion of the fuel consumed by the baking unit is provided. It should be noted that the major portion of the decarbonation reaction takes place in the preheater.

More accurately, in a typical dry mode operating plant, 60 to 65% of the fuel is fed into the precalcinator, and the remainder to the furnace. 85% approximately of the decarbonation reaction occurs before entering the furnace. Thus, out of the 780 to 830 kg carbon dioxide emitted by the baking unit, 76% to 78% is generated at the preheater and precalcinator, and only 22 to 24% in the rotary furnace.

The object of the present invention is to remedy the drawbacks aforementioned while offering an economically viable method for manufacturing a cement clinker for limiting the carbon dioxide discharges into the atmosphere.

Another aim of the invention is to provide such a method which can be implemented in a plant technically close to that used normally for the production of cement clinker.

Another aim of the invention is to provide such a plant as such.

Other aims and advantages of the present invention will appear in the following description which is given only by way of example and without being limited thereto.

### BRIEF SUMMARY OF THE INVENTION

The invention relates first of all to a method for manufacturing a cement clinker in a plant comprising: a cyclone preheater for preheating the raw matter; a precalcination reactor fitted with one or more burners, for providing heat to the cyclone preheater; a rotary furnace, fitted with a burner fed with fuel; a clinker cooler with blown-air cooling, at the exit from said rotary furnace generating hot gas; and a method wherein the raw matter is preheated and decarbonated in said cyclone preheater and/or said precalcination reactor; and the clinker coming out of the furnace is cooled in said clinker cooler.

According to the invention, the fumes generated by the rotary furnace and the gases from the preheater are separated so that said fumes and said gases from the preheater are not mixed together. The precalcination reactor is fed with an oxygen-rich gas whose nitrogen content is lower than 30%, forming the single oxygen source of said reactor. A portion of the gases from said cyclone preheater is recycled in said precalcination reactor, possibly said cyclone preheater, so as to obtain an adequate flux necessary for suspending matter in said preheater, while the other portion of the carbon dioxide-rich gases from said cyclone preheater is adapted in the perspective of a treatment for limiting the amounts of carbon dioxide discharged into the atmosphere, such as for example, sequestration.

Also disclosed is a plant for manufacturing a cement clinker enabling in particular the implementation of the method, comprising: a cyclone preheater for preheating the raw matter; a precalcination reactor fitted with one or more burners, for providing heat (hot gases) to the cyclone preheater; a rotary furnace, fitted with a burner fed with fuel; and a clinker cooler with blown-air cooling, at the exit from said rotary furnace generating hot gas.

According to the invention, the plant moreover includes: separate ducts for the fumes of the rotary furnace and the gases from the preheater so that said fumes and said gases are not mixed together; a source of an oxygen-rich gas whose nitrogen content is lower than 30%, feeding the precalcination reactor; and a duct for recycling a portion of the gases from said cyclone preheater in the precalcination reactor, possibly said cyclone preheater.

### BRIEF DESCRIPTION OF THE SEVERAL VIEWS OF THE DRAWINGS

The invention will be understood better when reading the following description accompanied by the appended drawings among which:

FIG. 1 illustrates diagrammatically an example of the manufacturing method implemented in a plant, according to the invention in a first embodiment,

FIG. 2 illustrates a method for manufacturing a cement clinker and the related plant, according to the invention in a second embodiment.

### DETAILED DESCRIPTION OF THE INVENTION

The invention also relates to a method for manufacturing a cement clinker in a plant.

Said plant comprises: a cyclone preheater for preheating the raw matter; a precalcination reactor 4 fitted with one or more burners, for providing heat in particular in the form of hot gases to the cyclone preheater; a rotary furnace 1, fitted with a burner fed with fuel; and a clinker cooler 5 with blown-air cooling, at the exit from said rotary furnace generating hot gas. It is thus a plant comprising a cyclone preheater, a precalcination reactor, a rotary furnace and a clinker cooler in a manner equivalent to the plants of the prior art.

According to the method: the raw matter is preheated and decarbonated (for their greatest part) in said cyclone preheater 3, 3a and/or said precalcination reactor 4; and the clinker coming out of the furnace is cooled in said clinker cooler 5.

According to the manufacturing process of the invention: the fumes generated by the rotary furnace and the gases from the preheater 3, 3a are separated so that said fumes and said gases from the preheater 3, 3a are not mixed together; the precalcination reactor 4 is fed with an oxygen-rich gas 9 whose nitrogen content is lower than 30%, forming the single oxygen source of said reactor 4; and a portion 8a of the gases 8 from said cyclone preheater 3, 3a is recycled in said precalcination reactor 3, possibly said cyclone preheater 3, 3a, so as to obtain an adequate flux necessary for suspending matter in said preheater, while the other portion 8b of the carbon dioxide-rich gases from said cyclone preheater 3, 3a is adapted in the perspective of a treatment for limiting the amounts of carbon dioxide discharged into the atmosphere.

Since three quarters approximately of the carbon dioxide are generated in the preheater and the precalcination reactor, the invention thus consists in concentrating CO2 at least in these parts of the plant.

The fumes 10 generated by the furnace 1 and those of the preheater 3, 3a and reactor 4 assembly are hence separated. Conversely, in a traditional cement plant, the fumes from the furnace feed the preheater/precalcinator assembly with hot gas, on the one hand for providing hear in this assembly, but also for creating a gas flux in the assembly necessary for suspending the matter.

In the plant according to the invention, the fumes from the furnace do not feed the preheater/precalcinator assembly. With regard to a traditional plant, a double operating unbalance is created, on the one hand the gas flux in the preheater is not sufficient any longer for the suspension of matter, on the other hand the thermal flux is not sufficient any longer for obtaining the desired preheating.

According to the plant of the invention, such unbalance is restored in whole or in part thanks to the recycling of portion 8a of the gases 8 coming out of the preheater. The portion of the recycled gases is such that it enables to obtain an adequate flux necessary to the suspension of the matter in the preheater.

More precisely, according to an embodiment, the portion 8a of the gases 8 coming out of the preheater is recycled so as to obtain a mass flow rate ratio between the treated matter and the flux necessary for suspending matter ranging from 0.5 kg/kg to 2 kg/kg.

When fed directly towards the precalcination reactor 4, the combustion gas in the reactor 4 is a mixture of the oxygen rich gas 9 and of the carbon dioxide-rich recycled portion 8a. Advantageously, this mixture prevents the combustion gas from being over-concentrated in oxygen and thus avoids the creation of too strong a flame in the reactor 4 which might damage it.

Additionally, said recycling of the portion 8a allows recycling an amount of heat generated by the preheater 3, 3a and the precalcination reactor 4. For further reducing the consumption of fuel in the reactor 4, the method may include a step wherein the portion 8a of the gases recycled in the precalcination reactor 4, possibly the preheater 3, 3a, is reheated via an exchanger 11, thanks in particular to the heat contained in the fumes 10 of the rotary furnace 1 and/or to a portion of the hot gas generated by said clinker cooler 5.

More precisely, according to an embodiment: a first portion 60 of the hot gas generated in said clinker cooler 5, or so-called secondary air, is directed to the rotary furnace 1 to be used as combustion air, especially by the burner(s) of the furnace 1; a second portion 6 of the hot gas generated in said clinker cooler 5, so-called tertiary flux, defined by a temperature at least equal to 750° C. is directed and then carried separately from the first portion to said exchanger 11, so as to reheat the portion 8a of the recycled fumes; and a third portion 7, so-called excess flux, of the hot gas generated in said clinker cooler, is extracted.

Possibly, the fumes 10 from the furnace 1 are dedusted in a cyclone 12 and the hot matter thus collected is injected into the preheater 3, 3a even into the precalcination reactor 4.

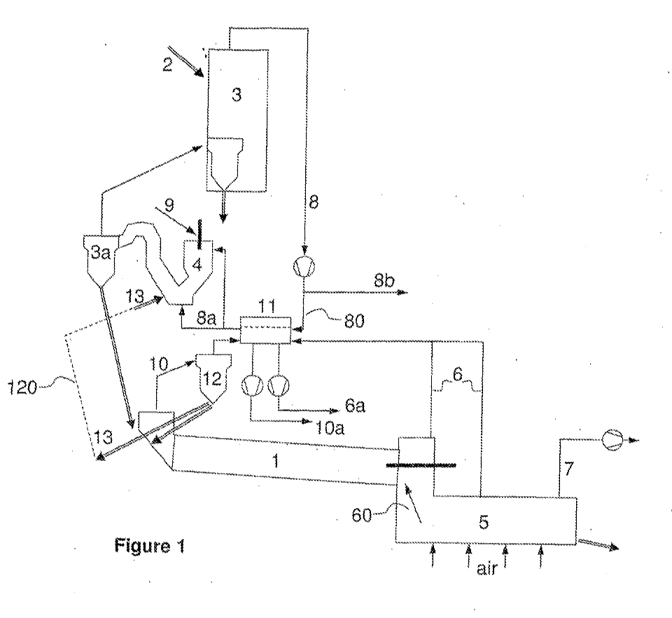

We shall now describe partially the example of FIG. 1 and more particularly the way that the recycled gases 8a are reheated by the exchanger 11.

In this example, the cooling gas of the clinker cooler 5 is air and thus contains a significant portion of nitrogen.

The air from the cooler is divided into three fluxes. A portion 60 of the hot gases generated in said clinker cooler, or so-called secondary air, is directed to the rotary furnace 1 to be used as combustion air in the furnace.

A second portion 6 of the hot gases generated in said clinker cooler, so-called tertiary flux, defined by a temperature at least equal to 750° C. is carried separately from the first portion 60 to said exchanger 11, so as to reheat the portion 8a of the recycled gases.

Finally, the third portion 7, with temperature lower than the temperature of the tertiary flux, is extracted and may be used for the production of mechanical energy, possibly electricity.

The fumes 10 from the furnace are led to a cyclone 12 for dedusting purposes. The dusts collected in the cyclone 12 are led to the precalcination reactor 4. The dedusted fumes run through the exchanger 11 so as to contribute, with the tertiary flux 6, to reheating the portion 8a of the recycled gases.

Downstream of the exchanger 11, the residual heat of the gases 6a originating from the tertiary flux and from the fumes 10 originating from the rotary furnace 1 may also be used for the production of mechanical energy, possibly electricity.

In this example, the exchanger 11 enables the exchange of heat between three fluxes, namely the portion 8a of the recycled gases, the tertiary flux 6 and the fumes 10. Thus by exchanger 11 is meant an exchanger in the broadest sense which, possibly, may include several exchanger modules. Generally speaking, in this example particularly, the heat contained in the gases 6a, 10a, more particularly the fumes 10 from the furnace 1 and/or the tertiary flux generated by the clinker cooler, at output from said exchanger 11, as well as the excess flux 7 heat, even the other portion 8b of the non recycled fumes, is used at least partially for the generation of energy, in particular electricity.

In this example of FIG. 1, the portion 8b, in particular the non recycled portion, of carbon dioxide rich gas may also be used at least partially as a pneumatic transport fluid for solid and/or pulverisation fuels for the liquid fuels feeding the burner(s) of the precalcination reactor 4 and/or as a pneumatic cleaning fluid of the cyclone preheater 3, 3b.

It will be noted that in this example of FIG. 1, only the gases generated by the assembly composed of the precalcination reactor 4 and of the cyclone preheater 3, 3a are intended for being treated so as to limit the discharges of carbon dioxide. Indeed, the nitrogen-rich fumes from the furnace 10 are not suitable for such a treatment, in particular a sequestration.

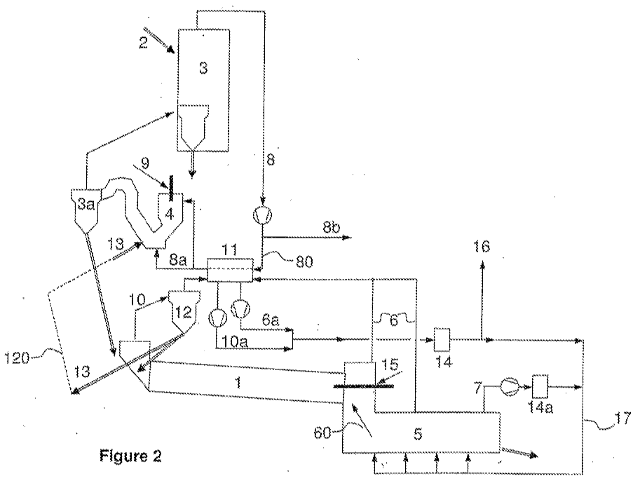

According to another embodiment, illustrated on FIG. 2, the carbon dioxide-rich gases of the rotary furnace are also concentrated for the purpose of a treatment in order to limit the discharges of CO2 into the atmosphere. More particularly, according to this embodiment: the burner of the rotary furnace 1 is fed with an oxygen-rich gas 15 whose nitrogen content is lower than 30%, forming-the single oxygen source of the furnace; and a portion 17 of the gases generated by the rotary furnace 1 and of the hot gas generated by the clinker cooler 5 which is cooled for feeding said cooler 5 with cooling gas, is recycled, while the other portion 16 of the carbon dioxide-rich gases is adapted in particular for sequestrating carbon dioxide.

Possibly, according to the embodiment of FIG. 2, a portion of the carbon dioxide-rich gases 8b, 16, respectively of the assembly composed of the precalcinator 4/cyclone preheater 3, 3a and of the assembly consisting of the rotary furnace 1 and of the clinker cooler 5, as a pneumatic transport fluid for solid fuel and/or as a pulverisation fluid for the fuels feeding the burner of the rotary furnace and/or as a fluid feeding the automatic pneumatic cleaning devices of the inlet chamber of the furnace 1 and of the cooler 5.

We shall describe more particularly in detail the example of FIG. 2. In this example, the gases of the cyclone preheater 3, 3/precalcination reactor 4 assembly, on the one hand and of the rotary furnace 1/clinker cooler 5 on the other hand, are recycled independently.

More particularly, in this example illustrated on FIG. 2, an oxygen-rich gas 15 feeds the burner of the rotary furnace 1 forming the single oxygen source of the furnace.

The cooling gas from the clinker cooler 5 consists ofrecycled gases, derived for one part from the gases generated by the clinker cooler 5, and for another part from the fumes 10 of the furnace.

Also, the cooling gas is rich in carbon dioxide. A portion 60 of the hot gas generated in the clinker cooler 5, also called secondary flux, is directed towards the rotary furnace 1. More precisely, it is mixed with the oxygen-rich gas 15, thereby limiting the oxygen concentration of the combustion gas so that the flame of the furnace burner is not too strong, so as not to damage said furnace.

A second portion 6 of the hot gases, also rich in carbon dioxide, generated in said clinker cooler 5, so-called tertiary flux, defined by a temperature at least equal to 750° C. is carried separately from the first portion to the exchanger so as to reheat the portion 8a of the recycled gases.

A third portion 7 of the hot gas generated in the clinker cooler, with lower temperature, is intended for recycling with a portion of the fumes 10 from the furnace in the clinker cooler 5.

More precisely, the fumes from the furnace 10 are dedusted in a cyclone 12. The hot dusts collected by the cyclone 12 are directed into the precalcination reactor 4 and/or towards the furnace 1. The dedusted fumes 10 run through the exchanger 11 so as to reheat the portion 8a of the recycled gases from the preheater 3, 3a.

In the same manner, said portion 6 of the hot gases generated in the clinker cooler 5, so-called tertiary flux, defined by a temperature at least equal to 750° C. is carried to the exchanger 11, so as to reheat the portion 8a of the recycled gases.

The exhaust gases out of the exchanger 11, namely the gases 10a derived from the fumes 10 and the gases 6a originating from the tertiary flux are then injected into an exchanger 14 for cooling purposes. A portion of these gases 16 is not recycled while the other is directed towards the clinker cooler 5 so as to feed it with cooling gas.

In the same manner, said excess flux 7 is cooled in another exchanger 14a and is also used as a cooling gas for the clinker cooler 5.

Possibly, a portion of the gases 8b/16 rich in carbon dioxide, in particular non recycled, derived respectively on the one hand from the precalcination reactor 4/cyclone preheater 3, 3a assembly and on the other from the clinker cooler 5/rotary furnace 1 assembly, can be used as a pneumatic transport fluid for solid fuel and/or as a pulverisation fluid for the fuels feeding the burner of the rotary furnace 1 and/or as a fluid feeding the automatic pneumatic cleaning devices of the inlet chamber of the furnace 1 and of the cooler 5.

Generally speaking, the oxygen rich gas 9, feeding the precalcination reactor 4 may have a nitrogen content of less than 5%. If applicable, the oxygen rich gas 15, feeding in particular the burner of the rotary furnace 1 according to the example of FIG. 2, may also have a nitrogen content lower than 5%.

The invention also refers to a plant for the manufacture of cement clinker as such. Said plant comprises: a cyclone preheater 3, 3a, for preheating the raw matter 2; a precalcination reactor 4 fitted with one or more burners, for providing heat to the cyclone preheater 3, 3a; a rotary furnace 1 fitted with a burner fed with fuel; and a clinker cooler 5 with blown-air cooling, at the exit from said rotary furnace 1 generating hot gas.

According to the invention, the plant includes: separate ducts for the fumes 10 of the rotary furnace 1 and the gases from the preheater 3, 3a so that said fumes and said gases are not mixed together; a source of an oxygen-rich gas 9 whose nitrogen content is lower than 30%, feeding the precalcination reactor 4; and a duct 80 for recycling a portion 8a of the gases 8 from said cyclone preheater 3, 3a in the precalcination reactor, possibly said cyclone preheater 3, 3a. There may be in particular the plants described previously on FIGS. 1 and 2, enabling the implementation of the method according to the invention.

In a general sense, an exchanger 11 may co-operate with the fumes 10 of the rotary furnace and at least one portion of the hot gas generated by the clinker cooler 5 for reheating the recycled portion 8a of the gases 8 coming out of the cyclone preheater 3, 3a.

A cyclone 12 may be provided for dedusting the fumes 10 of the rotary furnace 1. A duct 120 possibly enables feeding the dust collected by the cyclone 12 in the precalcination reactor 4, possibly in the reheater 3, 3a.

Possibly, in particular according to the example of FIG. 2, the plant may further exhibit: a source of an oxygen-rich gas 15 whose nitrogen content is lower than 30%, feeding the burner of the rotary furnace 1; and ducts for recycling in the clinker cooler 5 a portion of the fumes 10 of the rotary furnace 1 and of the hot gas generated by said clinker cooler 5, a set of exchangers 11, 14, 14a for cooling the recycled gases for feeding said clinker cooler 5 with a cooling gas.

We shall now describe the performances of a state-of-the-art plant then those expected with the plant previously described and illustrated on FIG. 1, and finally those of the plant described previously and illustrated on FIG. 2.

State of the art: The plant in question, as known in the art, is a midsize clinker production unit, or representative of the capacity of a large number of existing units and which produces 5,000 tons clinker per day out of an output of 337 ton/hour of raw matter.

Such a plant of the state-of-the-art consumes 3,000 per kg of produced clinker, supplied in the form of fuel among which 62.8% are injected at the level of the precalcination reactor. Let us consider the case where fuel is oil coke, having a calorific power lower than 34,300 kJ/kg and a 2% nitrogen content.

The clinker cooler generates among others 117,000 Nm3/h tertiary air at 890° C., which feeds the combustion of the precalcination reactor, and 210,000 Nm3/h exhaust air at 245° C. The fumes from the cyclone preheater have a flow rate of 286,200 Nm3/h and a temperature of 320° C. The mass flowrate ratio between the fed matter and the fumes of the preheater is 0.82.

The composition of the generated fumes, coming out of the preheater is:
oxygen: 3.6%
water: 7.1%
carbon dioxide: 29.6%
nitrogen: 59.7%.

The fumes from the cyclone preheater have a flow rate of 86,200 Nm3/h and a temperature of 1,160° C. They are used in the cyclone preheater. The composition of the fumes generated in the furnace is:
oxygen: 3.2%
water: 5.9%
carbon dioxide: 21.5%
nitrogen: 69.4%.

Seen in this light, 78.1% of the total amount of carbon dioxide is generated in the preheater and only 21.9% in the rotary furnace.

### Example 1 According to the Invention

The plant considered is comparable to the state in the art but this time the concentration of carbon dioxide is implemented in the preheater, according to the invention illustrated on FIG. 1.

Fuel is fed in the precalcination reactor, that is to say 1,972 MJ per ton of generated clinker. The operation of the furnace is globally not modified with respect to the state of the art with a consumption of 1,117 MJ per ton of clinker. The requirements in oxygen for the combustion in the precalcinator are 27,650 Nm3/h, provided in the form of pure oxygen.

Thus, 235,600 Nm3/h fumes are generated at 325 C among which 150,800 Nm3/h are recycled and 84,800 Nm3/h are extracted for treating the CO2. The mass flowrate ratio between the fed matter and the fumes of the preheater is 0.82 as in the example of the state of the art.

The composition of the generated fumes, coming out of the preheater is:
oxygen: 5.1%
water: 15.8%
carbon dioxide: 78.85%
nitrogen: 0.24%
CO2 on dry fumes: 93.6%.

The CO2 mass flow rate emitted by the fumes is 36.4 ton/hour; the CO2 mass flow rate which may be sequestrated from the fume extracted from the preheater is 131.34 t/h, i.e. 78.2% of the total.

The fumes from the furnace are carried through a cyclone which cleans them from the major portion of the contained dusts at 1,160° C., which dusts are reintroduced in the precalcination reactor.

145,800 Nm3/h tertiary air is sampled at 810° C., which are carried with the fumes from the furnace through an exchanger and transfer their energy to the recycled fumes from the preheater by cooling down to 350° C. Said fumes from the preheater are thereby brought to the temperature of 943° C. before being inserted in the precalcinator.

### Example 2 According to the Invention

The plant considered is that described previously and illustrated on FIG. 2, wherein the recycling of the fumes is moreover implemented in the rotary furnace according to the invention for concentrating carbon dioxide.

The operation of the preheater is identical to that of the previous example, with the oxygen feed and the recycling of the very CO2-rich fumes.

This time, a maximum portion of the heat contained in the gases is exchanged, on the one hand the fumes from the furnace and on the other hand, the hot gases generated in the clinker cooler, for lowering the temperature of these gases down to 135° C., by carrying the gases through various exchangers. The blowing on the clinker cooler is performed using these gases thus cooled down.

In the rotary furnace, the fuel requirements are 1,117 MJ per ton of generated clinker, and the combustion of fuel makes use of pure oxygen.

Thus, the fumes have the following composition:
oxygen: 6.5%,
water: 16.2%
carbon dioxide: 77.08%
nitrogen: 0.19%
CO2 on dry fumes: 92.0%.

These fumes are used and recycled, to obtain the following operation. 306,900 Nm3/h fumes are blown into the clinker cooler whose temperature has been lowered to 135° C. 53,500 Nm3/h very hot are generated, at 1,180° C., which are then directed towards the furnace; 112,900 Nm3/h hot gases are also generated at 810° C., among which a portion of the heat is used for reheating the recycled fumes from the preheater; finally 140.500 Nm3/h less hot gases are generated, at 262° C.

The fumes from the furnace, with a 77,600 Nm3/h flow rate and a 1,180° C. temperature, are used for reheating the recycled fumes from the preheater. 24,100 Nm3/h fumes are extracted for removing the carbon dioxide therefrom which accounts for 36.4 t/h. The remainder is cooled at 350° C. for use in the clinker cooler. The clinker is chilled in the cooler down to a 205° C. temperature. 14,700 Nm3/h pure oxygen is fed into the furnace for combustion.

Thus, the whole carbon dioxide of the plant is emitted in the form of fumes concentrated at less than 92%, compatible with a treatment for sequestration.

Naturally, other embodiments could have been contemplated by the man of the art without departing from the framework of the invention defined by the claims below.

1. A method for manufacturing a cement clinker in a facility comprising:
a cyclone preheater for preheating the raw matter;
a precalcination reactor, fitted with one or more burners, for providing heat to the cyclone preheater;
a rotary furnace, fitted with a burner fed with fuel;
a clinker cooler with blown-air cooling, at the exit from said rotary furnace, generating hot gas;
a method wherein:
the raw matter is preheated and decarbonated in said cyclone preheater and/or said precalcination reactor;
the clinker coming out of the furnace is cooled in said clinker cooler;
characterised in that:
the fumes generated by the rotary furnace and the gases from the preheater are separated so that said fumes and said gases from the preheater are not mixed together,
the precalcination reactor is fed with an oxygen-rich gases whose nitrogen content is lower than 30%, forming the single oxygen source of said reactor;
a portion of the gases from said cyclone preheater is recycled in said precalcination reactor, possibly said cyclone preheater, so as to obtain an adequate flux necessary for suspending matter in said preheater, while the other portion of the carbon dioxide-rich gases from said cyclone preheater is adapted in the perspective of a treatment for limiting the amounts of carbon dioxide discharged into the atmosphere, such as for example, sequestration.

2. A method according to claim 1, wherein said portion of the gases coming out of the cyclone preheater is recycled so as to obtain a mass flowrate ratio between the treated matter and the flux necessary for suspending matter ranging from 0.5 kg/kg to 2 kg/kg.

3. A method according to claim 1, wherein the portion of the recycled gases is reheated in the precalcination reactor even the preheater via an exchanger, thanks to the heat contained in the fumes of the rotary furnace and/or to a portion of the hot gas generated by the clinker cooler.

4. A method according to claim 3, wherein:
a first portion of the hot air generated in said clinker cooler or so-called secondary flux, is directed to the rotary furnace;
a second portion of hot gas generated is directed to said clinker cooler, so-called tertiary flux, defined by a temperature at least equal to 750° C., and it is carried separately from the first portion to said exchanger so as to reheat the portion of the recycled gases;
and a third portion, so-called, excess flux, of hot gas generated in said clinker cooler, is extracted.

5. A method according to claim 4, wherein the heat contained in the gases, more particularly the fumes from the furnace and/or the flux from the cooler at output from said exchanger, as well as the heat from the excess flux, even the other portion of the non recycled fumes, are used, at least partially, for the generation of energy, in particular electricity.

6. A method according to claim 1, wherein the fumes from the furnace are dedusted in a cyclone and the matter thus collected is inserted into the preheater, even in the precalcination reactor.

7. A method according to claim 1, wherein said non recycled portion of carbon dioxide rich gas is used at least partially as a pneumatic transport fluid for solid and/or pulverisation fuels for the liquid fuels feeding the burners of the precalcination reactor and/or as a pneumatic cleaning fluid of the cyclone preheater.

8. A method according to claim 1, wherein:
the burner of the rotary furnace is fed with an oxygen-rich gas whose nitrogen content is lower than 30%, forming the single oxygen source of the furnace;
a portion of the gases produced by the rotary furnace and of the hot gas generates by the clinker cooler which is cooled for feeding said cooler with cooling gas, is recycled, while the other portion of the carbon dioxide-rich gases, is adapted in the perspective of a treatment for limiting the amounts of carbon dioxide discharged into the atmosphere, such as for example, sequestration.

9. A method according to claim 1, in which a portion of the carbon dioxide-rich gases is used as a pneumatic transport fluid for solid fuel and/or as a pulverisation fluid for the fuels feeding the burner of the rotary furnace and/or as a fluid feeding the automatic pneumatic cleaning devices of the inlet chamber of the furnace and of the cooler.

10. A method according claim 1 wherein said oxygen-rich gas has a nitrogen content lower than 5%.

11. A cement clinker manufacturing plant, including:
a cyclone preheater for preheating the raw matter;
a precalcination reactor, fitted with one or more burners, for providing heat to the cyclone preheater;
a rotary furnace, fitted with a burner fed with fuel;
a clinker cooler with blown-air cooling, at the exit from said rotary furnace, generating hot gas,
characterised in that it comprises:
separate ducts for the fumes of the rotary furnace and the gases from the preheater so that said fumes and said gases are not mixed together;
a source of an oxygen-rich gas whose nitrogen content is lower than 30%, feeding the precalcination reactor;
a duct for recycling a portion of the gases from said cyclone preheater in the precalcination reactor, possibly said preheater.

12. A plant according to claim 11, wherein an exchanger co-operates with the fumes of the rotary furnace and at least a portion of the hot gas generated by said clinker cooler for reheating the recycled portion of the gases exiting from the cyclone preheater.

13. A plant according to claim 11, in which a cyclone is provided for dedusting the fumes of said rotary furnace.

14. A plant according to claim 13 wherein a duct enables to feed the dust collected by the cyclone in the precalcination reactor, even in the preheater.

15. A plant according to claim 11, further comprising:
a source of an oxygen-rich gas whose nitrogen content is lower than 30%, feeding the burner of the rotary furnace;
ducts for recycling in the clinker cooler a portion of the fumes of the rotary furnace and of the hot gas generated by said clinker cooler, a set of exchangers cooling the recycled gases for feeding said clinker cooler with a cooling gas.
